(19) United States
(12) Patent Application Publication
(10) Pub. No.: US 2006/0032972 A1
(43) Pub. Date: Feb. 16, 2006

(54) Vertical lift envelope

(76) Inventor: Milan J. Vavra, Santa Rosa, CA (US)

Correspondence Address: Milan Vavra, 235 Juanita Ct, Santa Rosa, CA, 95401-9047, US

(21) Appl. No.: 10/713,665

(22) Filed: Nov. 17, 2003

(51) Int. Cl. B64C 29/00

(52) U.S. Cl. 244/12.2

(57) ABSTRACT

Saucer shaped vehicle, with VTOL capabilities, having another tapered toroidal body inside. Between the upper half of the toroid and the outer skin lies a circular wing,. Air will be drawn horizontally from the opening situated at the bottom outer edge of the skin, and directed inward to a lower cone in the duct via two counter rotating fan assemblies. Compressed air will pass up and over the horizontal wing causing lift. Inner design will utilize the inside part of the skin as a high pressure area, top part of the wing as low pressure, where a vacuum will be generated. Similar configuration will be applied to the under part of the wing and top of inner toroid. Air will be diverted under the inner toroid to a secondary airfoil, with a similar design, causing additional lift, then returned to the duct to be reused, thus saving energy.

### REFERENCES CITED

U.S. Patents Documents

| | | | |
|---|---|---|---|
| 4773618 | 09/1988 | Ow | 244/23C |
| 4778128 | 10/1988 | Wright, et al | 244/23C |
| 4824048 | 04/1989 | Kyusik | 244/12.2 |
| 5152478 | 01/1992 | Cycon, et al | 244/12.2 |
| 5895011 | 04/1999 | Gubin | 244/12.1 |
| 6016991 | 01/2000 | Lowe, Jr | 244/5 |
| 6073881 | 06/2000 | Chen | 244/23C |
| 6086016 | 07/2000 | Meek | 244/17.11 |
| 6179247 | 06/2001 | Milde, Jr | 244/23A |
| 6270036 | 08/2001 | Lowe, Jr | 244/12.2 |
| 6270038 | 08/2001 | Cycon, et al | 244/12.3 |
| 6371406 | 05/2002 | Ow | 244/23C |
| 6402088 | 06/2002 | Syrovy, et al | 244/10 |
| 6450446 | 09/2002 | Holben | 244/34A |

### FEDERALLY SPONSORED R & D NONE

### BACKGROUND OF THE INVENTION

Extensive effort has been directed towards the development of aircraft capable of vertical take-off and landing from relatively small open areas. Wings are rudimentary at different speeds, for slow takeoff, wings are designed to maximize lift. At high speeds the structural design of the wing falls short because of the forward velocity of the craft, trying to configure between these lines becomes a major engineering problem

Rotary wing aircraft, helicopters, are one answer to the problem, but they require large exposed rotor blades which are vulnerable to strikes, and dangerous to persons on the ground. Helicopters achieve horizontal flight by cyclic and collective control of the blade pitch. These considerations lead to a complex control systems which are difficult and costly to maintain, and require considerable pilot training and skill.

One known approach to this type of aircraft is to use a ducted fan or fans mounted in the airframe for developing vertical thrust aligned with the aircraft center of mass. Horizontal thrust is developed either by deflecting the vertical thrust once takeoff has been achieved, or by operating a separate horizontal thruster.

Therefore I submit a design which will have the wing be set for maximum lift, but the wings will be circular and mounted above a toroidal inner structure (fuselage) and completely embodied or enveloped by an outer skin membrane, ducted fan assemblies will be in the center of the fuselage or toroidal inner structure, thus the design of the craft will not inhibit vertical takeoff and landing or horizontal high speed flight.

Assets: The vehicle will have a circular wing which greatly reduces the width of the craft, thus making a very compact vehicle with the same or heavier lift capability and a larger cargo area, and having the assembly shrouded by an envelope, unimpeded by outside forces, lifting capability remains fixed, no downwash or noise or hazard from exposed rotating blades.

Size limited only by propulsion/motor capabilities—from solar powered autonomous smaller units to hydrogen/plasma powered high altitude to passenger carrying lifting enveloped vehicles.

Thus, it is the object of the present invention to provide an improved lifting platform utilizing fixed inboard shrouded or enveloped wings.

### 1. FIELD OF THE INVENTION

This invention pertains to a field of aircraft capable of vertical take-off and landing and in particular relate to having inboard lifting wings, similar to conventional aircraft consequently improving control and stabilization of such aircraft in vertical flight or when making the transition to horizontal flight.

### 2. DESCRIPTION OF RELATED ART

Extensive effort has been directed towards the development of aircraft capable of vertical take-off and landing from relatively small open areas. Rotary wing aircraft, helicopters, are one answer to the problem, but they require large exposed rotor blades which are vulnerable to strikes, and dangerous to persons on the ground. Helicopters achieve horizontal flight by cyclic and collective control of the blade pitch. These considerations lead to a complex control systems which are difficult and costly to maintain, and require considerable pilot training and skill.

In order to overcome these difficulties, aircraft have have been proposed and designed to lift vertical via rotary nozzles for jet engines, deflector vanes for propeller drives, and pivotly mounted engines, plus others.

One known approach to this type of aircraft is to use a ducted fan or fans mounted in the airframe for developing vertical thrust aligned with the aircraft center of mass. Horizontal thrust is developed either by deflecting the vertical thrust once takeoff has been achieved, or by operating a separate horizontal thruster.

VTOL aircraft with a single vertical thruster, such as a ducted fan, present a special stability problems during the transition between vertical and hoizontal flight modes. In vertical flight close to the ground, the aircraft may be stabilized against wobbling by a cushion of pressurized air developed between the aircraft and the underlying ground surface. The same cushion of pressurized air, however, provides zero friction support and allows the aircraft to move easily or skitter in a horizontal plane, a problem which is addressed below. This effect is limited to the close proximity of the ground surface, and diminishes rapidly with altitude. During horizontal flight the aircraft attitude may be stabilized by conventional controls. An interval exists, where the the aircraft's altitude no longer allows the built up cushion of compressed air underneath, yet the horizontal airspeed is insufficient for effective use of the control surfaces. Some additional means must be provided for stabilizing the aircraft during this transition or interval. Adjustable thrust deflectors and muliple thrusters have been employed which continuously respond to and counteract deviations of the airframe from a reference attitude.

One known method involves the use horizontal counter rotating fans as a gyroscopic rotor to obtain both vertical thrust and horizontal stability. The prior designs fall into two groups, the first group comprises of aircraft with no aerodynamic control surfaces active during horizontal flight and therefore require gyroscopic stabilization in all phases of flight, and the second group are stabilized by means of aerodynamic surfaces during forward flight without resort to inertial stabilization. In the latter case, the known designs do not provide for a transition between gyroscopically stabilized flight and purely aerodynamically stabilized flight.

It is desirable to disable the gyro rotor in horizontal flight, as it hinders the ability to bank the aircraft during turns in forward flight.

A continuing need exists for VTOL aircraft which are stable during vertical flight without hindrance to aerodynamically winged horizontal flight.

### BRIEF SUMMARY OF THE INVENTION

Winged flight, where lift is generated by airflow over aerodynamic surfaces, is considerably more efficient than flight sustained by generating vertical thrust. The Vertical Lift Envelope refers to a structure that provides lift for vertical flight utilizing wings or airfoils. The inner body designed in a toroidal shape and acts as a structural and storage area as well as having supporting struts, which also connect to the wings and then to the outer skin, which completely envelopes or surrounds the above mentioned.

Propulsion mechanisms, encompass a counter rotating propeller assembly located in the central duct. Each propeller assembly has it's own motor or power unit. Air will be drawn into the vehicle from an opening slot which completely surrounds the craft, 360 degrees, on the underside, outer area and drawn by the propulsion system inward to the cone shaped casings and moved upward, be compressed and accelerated by the propellers, thus causing compressed medium velocity air to move over the inner wing providing lift. At the outer edge of the toroid compressed air will be forced under the structural area and to another winged form or airfoil, giving additional lift and then passing over the opening slot back to the central duct to be recirculated, thus saving power usage.

The outer skin membrane and the inner toroid structure will be designed that pressure variations caused by the moving fluid, air or gas will have the maximum influence where required and the least effect when moving in a negative manner to gain lift.

An example would be where the fluid, air make a 180 degree turn downward before encountering another lifting body. The outer circumference of the skin membrane will be moved further away from the main body shape, toroid, in that the air would loose density prior to being compressed and increasing in velocity when meeting the secondary lifting body or airfoil.

### BRIEF DESCRIPTION OF THE DRAWINGS

FIG. 1 Outer Outline Page 20

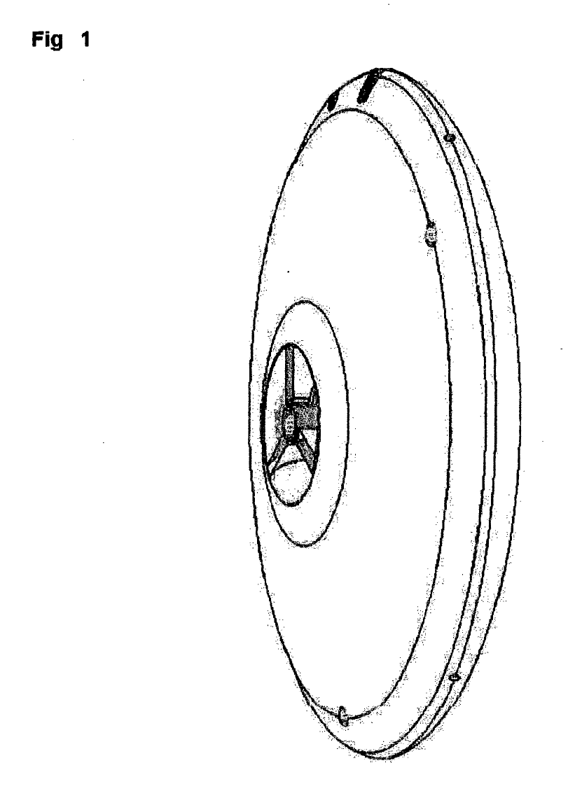

FIG. 2 Perspective with Sectional View Page 21

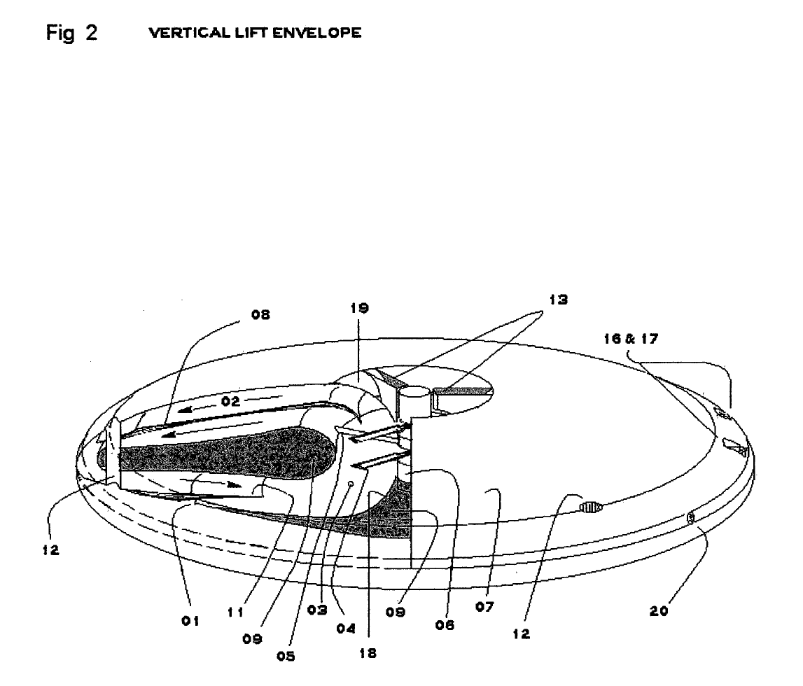

FIG. 3 Rear View Page 22

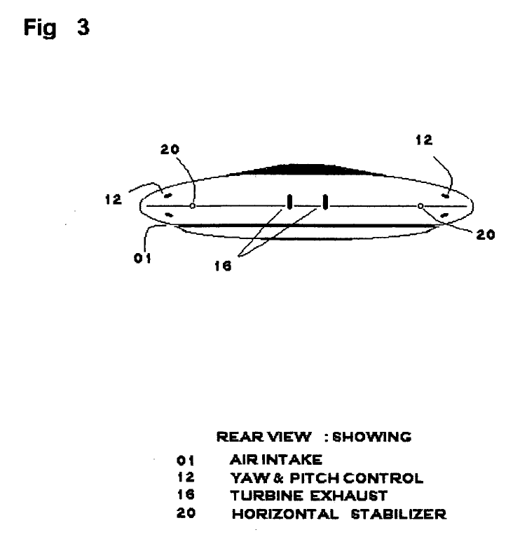

FIG. 4 Structural Assembly Page 23

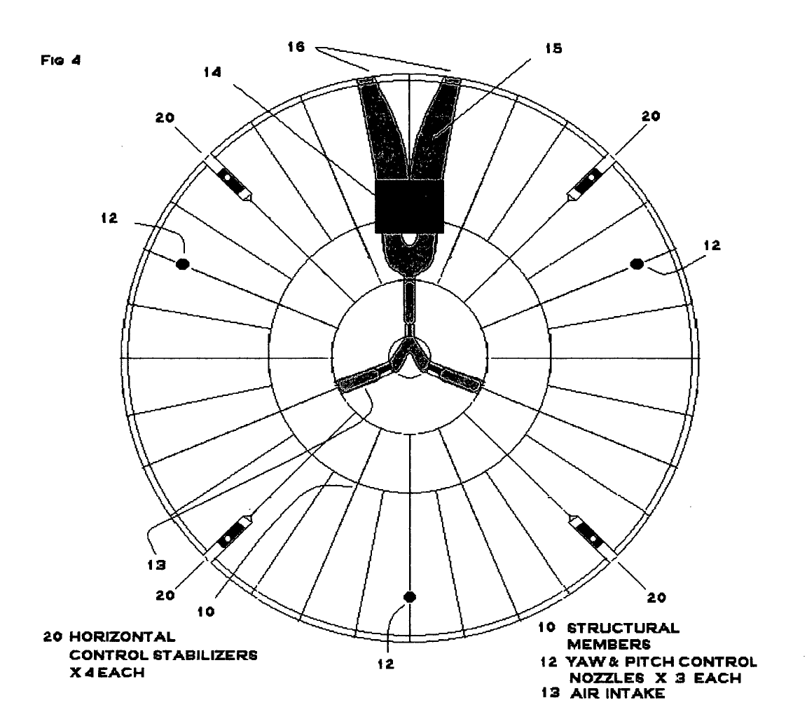

FIG. 5 Wing Design Page 24

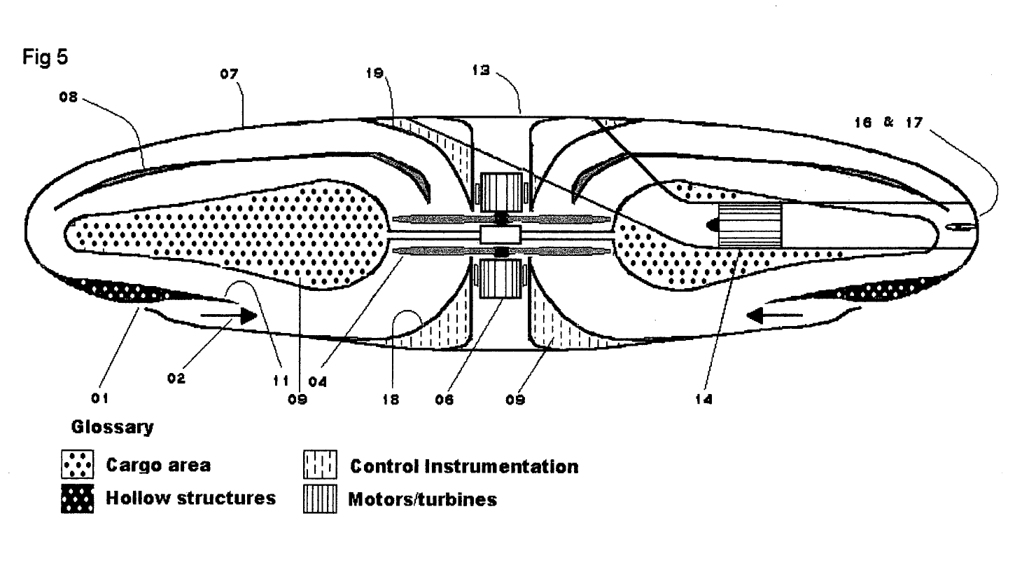

FIG. 6 Nozzle—Yaw and Pitch Control Page 25

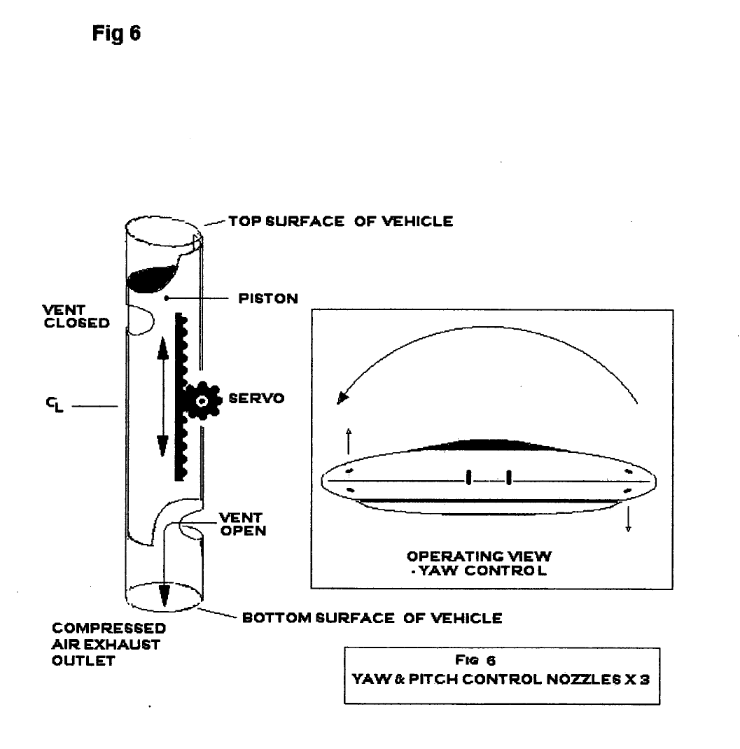

FIG. 7 Stabilizers—Horizontal Control Page 26

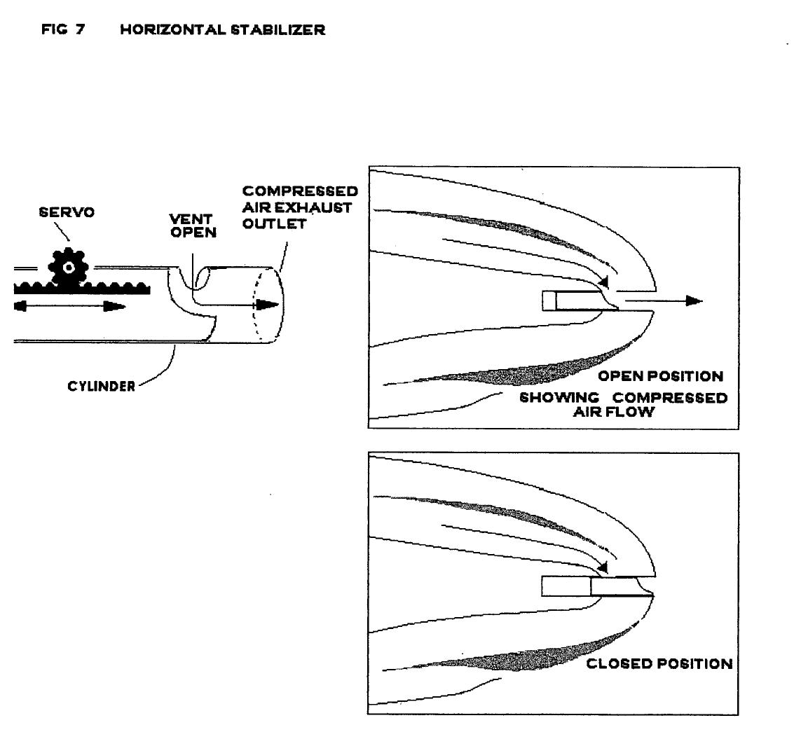

FIG. 8 Intake Ring Page 27

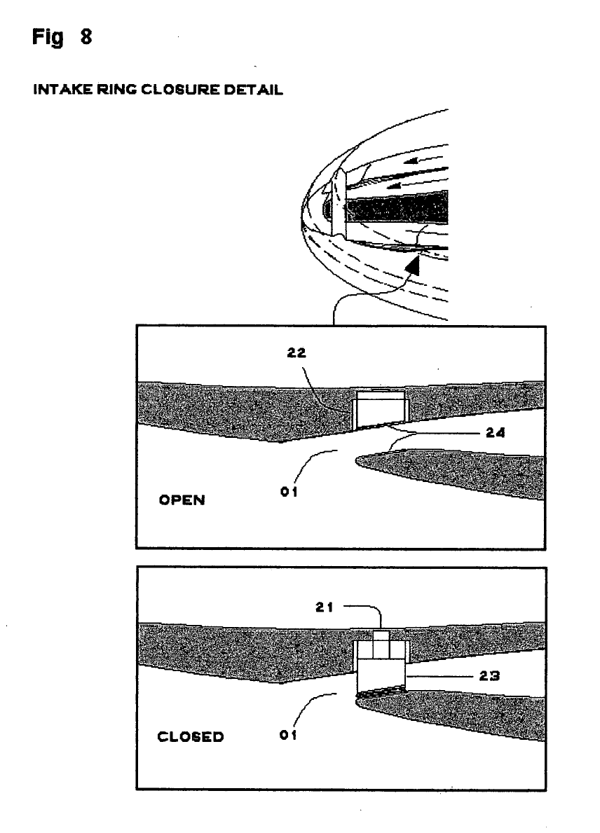

### DETAILED DESCRIPTION OF THE INVENTION

Definition of Design: Vertical lift envelope, main structure is a toroidal shape 09(doughnut, circular, including inner hole). Upper and lower surfaces of the toroid are concave and tapered to a thinner outer diameter.

Above the upper surface of the toroid (fuselage) is mounted a circular wing,08, and below the toroid is a circular airfoil,11.

The complete structure is enveloped with an outer skin membrane,04, away from the wing surface. Structural members,10, connect and hold the outer skin,07,and wing area to the inner toroid structure or fuselage,09.

The main wing or lifting body,08, on the top side of the toroid structure, 09, has the leading edge facing the center duct opening, 03, and the trailing edges of the wing ending at the outer edge of the toroidal structure where the air/gas makes a 180 degree downward turn to the underside of the toroid. The second lifting body or airfoil, 11,will be mounted on the underside of the support structure with the leading edge facing the outer portion of the toroid (fuselage) and the trailing edge close to the duct,18. The wings and complete structure will be surrounded, enveloped, away from the wing surface, with a outer skin membrane,07, which also functions as a compressed air guide to contain the air or gas, moving from the center duct,19, where the horizontal propeller assemblies,04, and power units,06, are located to the outer edge forcing air/gas to move over the wings,08, thus causing lift.

Air intake, to maintain a constant pressure ie when compressed, will be provided by an opening slot,01, formed in a ring, 360 degrees, on the underside of the vehicle, this allows balance the air/gas upon demand of the propulsion systems and exhaust air when compression is dropped.

When the demand for additional air/gas is not required, it will be used over and over, improving efficiency and reducing the power required.

The front portion of the intake slot has the capability of closing as forward velocity or movement is generated, to prevent turbulent air reaching the vertical rotor assemblies.

Propulsion will be provided by two counter rotating assemblies,06, each with a plurality of propellers,04, mounted within the duct, each assembly has it's own engine,06. For more efficiency flow/straightening vanes,05, are mounted between the two counter rotating propeller assemblies. Two engines and rotor assemblies are required to prevent spin and to control or pilot the craft in a set horizontal or vertical direction.

Air will then be drawn inward and guided by a cone shaped casing,18, to the inner duct,03, where the propulsion systems are located.

Compressed gas/air is forced upward and then guided by an upper inverted cone,19, to flow on the inner or underside of the skin membrane. This leads to having the wing design structure to be upside down to conventional lifting aircraft wings. This design will cause a vacuum to be generated on the upper surface of the inner wing, causing lift.

Lower lifting body or airfoil,11,is designed to force high pressure air/gas to the underbody of the toroid thus creating additional lift. The taper on the toroidal fuselage and the outer skin membrane on both the upper and lower portions of the vehicle will be such that the cubic volume of air/gas will remain constant, starting and ending at the central duct. Exception will be at the outer area of the toroid and lower duct areas were the volume increases to prevent negative lift being generated when the air/gas mixture flow is forced under the fuselage and when approaching the lower inner cone prior to being compressed again by the pluarity of propellers.

The assets of having a circular wing is that the width of the craft is greatly reduced, thus making a very compact vehicle with the same or heavier lift capability and having a larger cargo area.

Horizontal Control Stabilizers, four each, to enable the craft to remain in a fixed position during vertical ascent when adverse weather conditions prevail. Turning: Left and right turns will be generated by speeding up one of the propulsion unit.

Yaw and pitch will be controlled by three nozzles,12, mounted in a triangular pattern on the outer edge of the skin surface. The nozzles will force compressed air/gas, generated by the propulsion units, to exit vertically upwards or downwards, independently as required to correct yaw or pitch. Reverse flight is accomplished from forward flight by idling the horizontal turbine, rotating the craft 180 degrees prior to reengaging the turbine to full power, thus stopping the craft in mid flight and moving in the opposite direction.

The above encompasses the method of vertical flight (VTOL) in this design. Horizontal propulsion utilizes a fan or turbine,14, mounted in the structural storage area just aft of the central duct, air will drawn in from top center of the vehicle through three intake manifolds,13, were the air is channeled to a central intake and drawn into the turbine,14, upon compression the gas is expelled and split into two exhaust manifolds and exited through two nozzles,16, equipped with directional vanes,17.

Dual exhausts and two directional vanes are required giving this type of spherical craft better stability and control when transferring from vertical to horizontal modes or accelerating in horizontal flight. The main objective is to prevent this type of vehicle getting into a nose down attitude, as is well known in VTOL type aircraft.

### SUMMARY

Assets: circular wing verses straight, shrouded by an envelope, unimpeded by outside forces, lifting capability remains fixed, no downwash or noise, or hazards from exposed spinning blades. ie helicopters.

Size limited only by propulsion/motor capabilities—from solar powered autonomous smaller units to hydrogen/plasma powered high altitude to passenger carrying lifting enveloped vehicles.

Thus, it is the object of the present invention to provide an improved lifting platform utilizing fixed inboard shrouded wings.

1.0 Encompassing an enclosed secondary toroidal fuselage, between are two counter rotating propulsion units.

2.0 Between the upper half of the toroid and the outer saucer skin lies a circular wing.

3.0 Inner part of the lower skin membrane will be designed to change the airflow from high to low pressure, eliminating negative lift.

4.0 Vertical propulsion systems will be provided by two counter rotating assemblies, mounted within the duct.

5.0 Turns will be generated by increasing or decreasing the revolutions of the propulsion systems, including reverse flight.

6.0 Yaw and pitch will be controlled by three nozzles, mounted in a triangular pattern on the outer edge of the skin surface.

7.0 Air Intake/Exhaust Slot, circular opening on lower circumference to balance air mixture.

8.0 Horizontal flight will be accomplished by a turbine located just aft of the duct.

9.0 Reverse flight is accomplished from forward flight by idling the horizontal turbine, and rotating the vehicle.
